(19) United States
(12) Patent Application Publication
(10) Pub. No.: US 2025/0206530 A1
(43) Pub. Date: Jun. 26, 2025

(54) Automated Warehouse

(71) Applicant: Daifuku Co., Ltd., Osaka-shi (JP)

(72) Inventor: Takanori Nakamura, Hinocho (JP)

(21) Appl. No.: 19/000,809

(22) Filed: Dec. 24, 2024

(30) Foreign Application Priority Data
Dec. 25, 2023 (JP) 2023-217875

(51) Int. Cl. B65G 1/04

(52) U.S. Cl. CPC B65G 1/0492; B65G 2203/045; B65G 2207/22

(57) ABSTRACT

An automated warehouse includes a storage facility, a first bogie, and a second bogie. The first bogie includes a power storage device, a travel driving device, and a control device configured to control the travel driving device. The control device includes a control unit, a heat generating device configured to generate heat, and a thermally insulated case. The control unit and the heat generating device are stored in the thermally insulated case.

### CROSS-REFERENCE TO RELATED APPLICATION

This application claims priority to Japanese Patent Application No. 2023-217875 filed Dec. 25, 2023, the disclosure of which is hereby incorporated by reference in its entirety.

### BACKGROUND OF THE INVENTION

### 1. Field of the Invention

The present invention relates to an automated warehouse.

### 2. Description of Related Art

For example, Japanese Unexamined Patent Application Publication No. 2019-108204 (JP 2019-108204) discloses a technology related to an automated warehouse. Hereinafter, reference numerals described within parentheses in the Description of the Related Art are reference numerals used in JP 2019-108204.

The automated warehouse in JP 2019-108204 includes a transport bogie (12) configured to transport an article (W), and a plurality of storage transport sections (6) arranged in an up-down direction. Each of the plurality of storage transport sections (6) includes a travel path (R) on which the transport bogie (12) travels, and a storing section (a storage shelf 11) configured to store the article (W). The travel path (R) includes a first travel path (R1) extending along a first direction (X), and a second travel path (R2) extending along a second direction (Y) perpendicular to the first direction (X) as viewed vertically. A plurality of second travel paths (R2) is arranged in the first direction (X) in such a manner as to be connected to the first travel path (R1). A plurality of storing sections is provided along each of the second travel paths (R2). The transport bogie (12) includes a first bogie (a child bogie 19) capable of traveling with the article (W) being thereon, and a second bogie (a parent bogie 18) capable of carrying the first bogie (19). In a case where the article (W) is transported to a storing section, the second bogie (18) travels on the first travel path (R1) with the first bogie (19) being on the second bogie (18). The first bogie (19) is transferred from the second bogie (18) to a given second travel path (R2) and transports the article (W) to the storing section as a storage destination.

In the meantime, in the automated warehouse described above, the storing section may be under a low temperature environment for the purpose of storing fresh food, frozen food, and the like, for example. In addition, a temperature difference between the storing section and other places in the automated warehouse may be large depending on the temperature set in the storing section. Under such a particular temperature environment, in a case where the first bogie that goes in and out of the storing section uses a device or a component vulnerable to low temperature or temperature changes, the first bogie easily causes a malfunction, which may decrease the operating rate of a facility.

### SUMMARY OF THE INVENTION

In view of the foregoing, in an automated warehouse including a first bogie configured to transport an article and a second bogie capable of carrying the first bogie, it is desired to reduce the rate of occurrence of a malfunction in the first bogie and restrain a decrease in the operating rate of a facility even when the first bogie travels under a particular temperature environment.

An automated warehouse according to this disclosure includes: a storage facility including a plurality of storing sections in each of which articles are storable to be aligned in a first direction as a particular direction along a horizontal plane, the plurality of storing sections being arranged in a second direction intersecting with the first direction as viewed vertically; a first bogie configured to travel along the first direction and transport an article in a corresponding storing section; and at least one second bogie capable of carrying the first bogie and configured to travel along the second direction outside the plurality of storing sections. The at least one second bogie includes a power supply section configured to supply electric power to the first bogie. The first bogie includes: a power storage device; a travel driving device configured to cause the first bogie to travel with use of electric power stored in the power storage device; and a control device configured to control the travel driving device. The control device includes: a control unit configured to generate a control signal for the travel driving device; a heat generating device configured to generate heat with use of at least either the electric power supplied from the power supply section or the electric power stored in the power storage device; and a thermally insulated case made of a heat insulation material. The control unit and the heat generating device are stored in the thermally insulated case.

With this configuration, even in a case where the control unit of the first bogie includes a component vulnerable to low temperature or temperature changes, the control unit is warmed by heat generated by the heat generating device, so that the control unit is easily maintained within an allowable temperature range. Accordingly, even in a case where the first bogie travels under a particular temperature environment such as a low temperature environment or an environment with a large temperature difference, for example, it is possible to reduce the rate of occurrence of a malfunction in the control unit.

In addition, in this configuration, since the control unit and the heat generating device are stored in the thermally insulated case, heat generated by the heat generating device is easily kept inside the thermally insulated case, and electric power to be consumed by the heat generating device is easily restrained. Accordingly, it is possible to downsize the power storage device of the first bogie.

Thus, with this configuration, in the automated warehouse including the first bogie configured to transport an article and the second bogie capable of carrying the first bogie, even when the first bogie travels under a particular temperature environment, it is possible to reduce the rate of occurrence of a malfunction in the first bogie and to restrain a decrease in the rate of operation of a facility.

Further features and advantages of the automated warehouse are made clear from the following description on exemplary and nonlimiting embodiments to be described with reference to the drawings.

### BRIEF DESCRIPTION OF THE DRAWINGS

FIG. 1 is a plan view of a storage facility;

FIG. 2 is a vertical section front view of part of the storage facility;

FIG. 3 is a perspective view of part of the storage facility;

FIG. 4 is a plan view schematically illustrating an internal structure of a first bogie;

FIG. 5 is a control block diagram;

FIG. 6 is a plan view schematically illustrating travel paths of the first bogie and a second bogie;

FIG. 7 is a control flow diagram; and

FIG. 8 is a control flow diagram.

### DESCRIPTION OF THE INVENTION

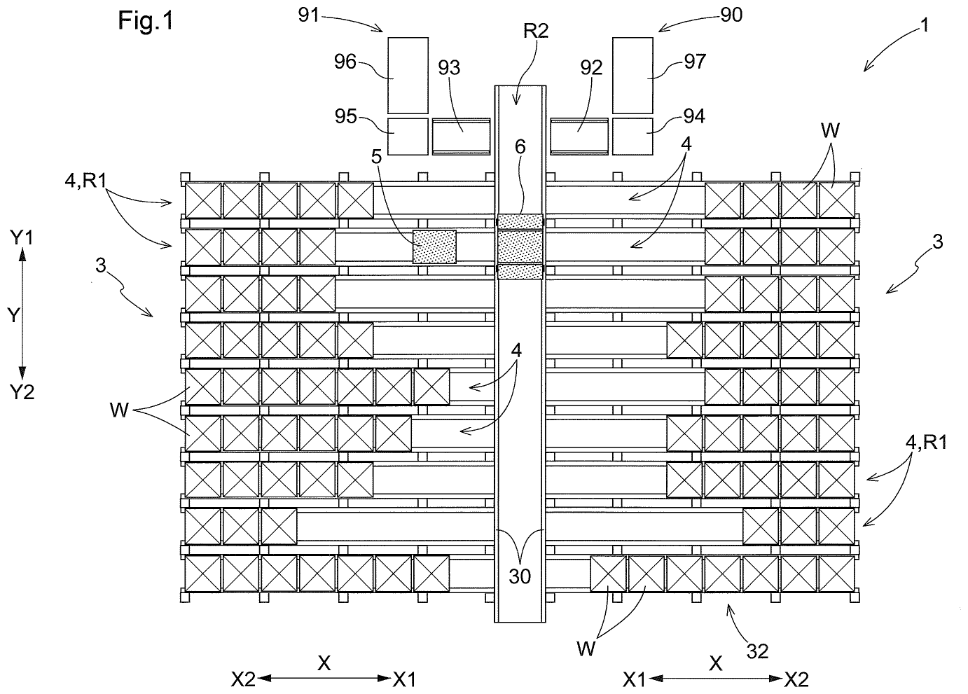

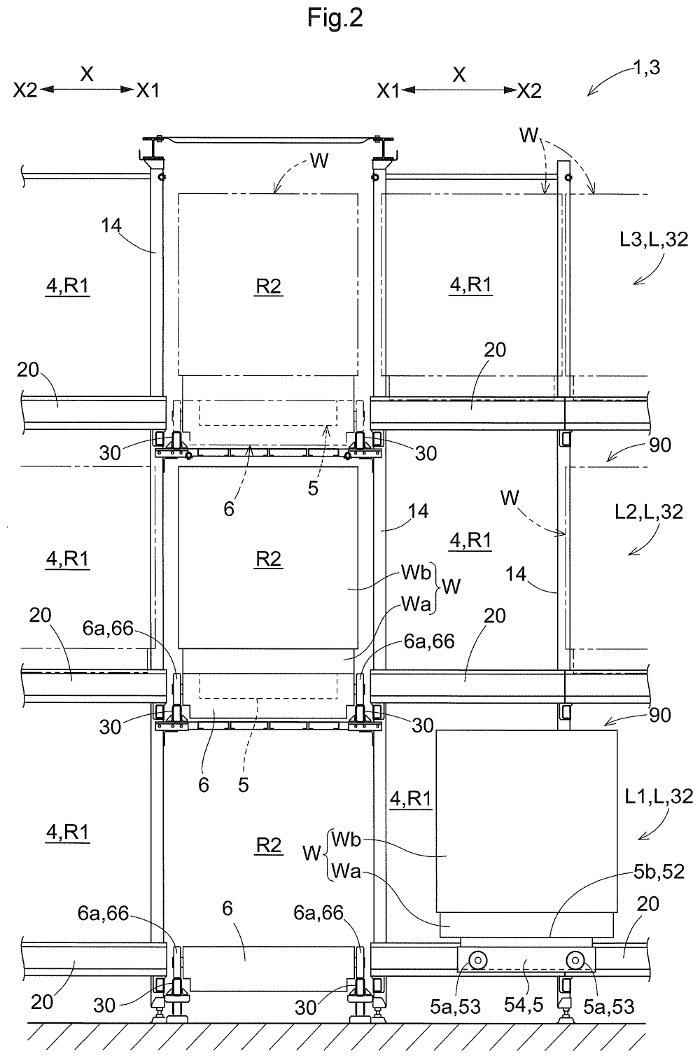

The following will describe an embodiment of an automated warehouse with reference to the drawings. As illustrated in FIGS. 1, 2, an automated warehouse 1 includes a storage facility 3 configured to store an article W, a first bogie 5 configured to transport the article W, and a second bogie 6 capable of carrying the first bogie 5. As illustrated in FIG. 1, the automated warehouse 1 also includes a loading unit 90 configured to load the article W into the storage facility 3, and an unloading unit 91 configured to unload the article W from the storage facility 3.

As illustrated in FIGS. 1, 2, a particular direction along a horizontal plane is defined as a first direction X, and a direction intersecting with the first direction X as viewed vertically (in a plan view) is defined as a second direction Y. Herein, the second direction Y is a horizontal direction perpendicular to the first direction X as viewed vertically. That is, the first direction X and the second direction Y are two horizontal directions perpendicular to each other.

One side in the first direction X is defined as a first-direction first side X1, and the other side in the first direction X is defined as a first-direction second side X2. In the meantime, one side in the second direction Y is defined as a second-direction first side Y1, and the other side in the second direction Y is defined as a second-direction second side Y2. Here, the first-direction first side X1 is a side in the first direction X which side is closer to a travel path (a second travel path R2) of the second bogie 6, and the first-direction second side X2 is the opposite side from the first-direction first side X1. Thus, regions on the opposite sides of the travel path of the second bogie 6 in the first direction X have respective first-direction first sides X1 reverse to each other. Herein, the second-direction first side Y1 is a side in the second direction Y which side is closer to the loading unit 90 and the unloading unit 91, and the second-direction second side Y2 is the opposite side from the second-direction first side Y1.

As illustrated in FIG. 1, the storage facility 3 includes a plurality of storing sections 4 arranged in the second direction Y, and each of the storing sections 4 can store articles W such that the articles W are arranged in the first direction X. The number of articles W storable to be arranged in the first direction X in one storing section 4 can vary depending on the dimension of the articles W in the first direction X. In the example illustrated in FIG. 1, one storing section 4 can store eight articles W at the maximum with the eight articles W being arranged in the first direction X.

As illustrated in FIGS. 1, 2, the storage facility 3 includes a plurality of storage floors 32 arranged in the up-down direction, and each of the storage floors 32 is provided with a plurality of storing sections 4. FIG. 2 illustrates an example of the storage facility 3 provided with three storage floors 32 arranged in the up-down direction. In FIG. 2, three levels L includes a first level LI, a second level L2, and a third level L3 sequentially from the lower side in the up-down direction. In FIG. 1, a plurality of (herein, nine) storing sections 4 is provided in a single storage floor 32 in such a manner to be arranged in the second direction Y. The plurality of storing sections 4 is provided for the opposite sides in the first direction X across the travel path (the second travel path R2) of the second bogie 6. Note that the number of storage floors 32 and the number of storing sections 4 provided for a single storage floor 32 are modifiable depending on the scale of the storage facility 3 appropriately.

As illustrated in FIGS. 1, 2, and 6, the first bogie 5 travels along the first direction X and transports the article W in the storing section 4. The first bogie 5 can carry the article W. The first bogie 5 is provided for each of the plurality of storage floors 32. In the present example, a single first bogie 5 is provided for each storage floor 32. In addition, as illustrated in FIGS. 1, 2, and 6, the second bogie 6 can carry the first bogie 5 and travels along the second direction Y outside the storing section 4. The second bogie 6 is provided for each of the plurality of storage floors 32. In the present example, a single second bogie 6 is provided for each storage floor 32. Thus, in the storage facility 3 of the present example, a single first bogie 5 and a single second bogie 6 are provided for each of the plurality of storage floors 32. In the meantime, a plurality of first bogies 5 and a plurality of second bogies 6 may be provided for each of the plurality of storage floors 32.

As illustrated in FIGS. 1, 2, and 6, the first bogie 5 is configured to travel on a path (a first travel path R1) along the first direction X which path is provided for each storage floor 32.

The second bogie 6 is configured to travel on a path (the second travel path R2) along the second direction Y which path is provided for each storage floor 32. A single storage floor 32 includes a plurality of first travel paths R1. The number of first travel paths R1 provided for each storage floor 32 is the same as the number of storing sections 4 provided for each storage floor 32. As illustrated in FIG. 1, each first travel path R1 is provided to overlap with its corresponding storing section 4 as viewed vertically. In FIG. 1, nine first travel paths R1 are provided on each side of the second travel path R2 in such a manner as to correspond to the storing sections 4. A single second travel path R2 is provided along the second direction Y in such a manner as to run through a central portion of the storage floor 32 in the first direction X, as viewed vertically. Note that, in the present example, the plurality of storage floors 32 has the same configuration but may have different configurations. For example, some storage floors 32 among the plurality of storage floors 32 or each of the storage floors 32 can have different numbers of storing sections 4, first travel paths R1, second travel paths R2, first bogies 5, and second bogies 6.

As illustrated in FIG. 1, the loading unit 90 and the unloading unit 91 are provided along the second travel path R2. More specifically, the loading unit 90 and the unloading unit 91 are provided for one end portion (herein, an end portion on the second-direction first side Y1) of the second travel path R2 in the second direction Y. In the present example, the loading unit 90 includes an inbound section 92, a first lifting and lowering device 94, and a loading conveyor 97. A plurality of inbound sections 92 is provided to correspond to the plurality of storage floors 32. The unloading unit 91 includes an outbound section 93, a second lifting and lowering device 95, and an unloading conveyor 96. A plurality of outbound sections 93 is provided to correspond to the plurality of storage floors 32. The following deals with the transport of the article W with the use of the loading unit 90, with reference to a process of transporting the article W from outside the automated warehouse 1 to the storing section 4. The article W from outside the automated warehouse 1 is put on the loading conveyor 97 and transported to the first lifting and lowering device 94. Then, the article W is transported to a corresponding storage floor 32 as a storage destination by the first lifting and lowering device 94. After that, the article W is transferred from the first lifting and lowering device 94 to the inbound section 92. The article W is delivered from the inbound section 92 to the second bogie 6 on the second travel path R2 which second bogie 6 carries the first bogie 5. Note that the inbound section 92 is a conveyor.

As illustrated in FIGS. 1, 2, and 6, the second bogie 6 (the second bogie 6 carrying the first bogie 5) that has received the article W travels on the second travel path R2 and stops at a position corresponding to a storing section 4 as a transport destination. The first bogie 5 carrying the article W separates from the second bogie 6 and travels on a first travel path R1 corresponding to the storing section 4 as the transport destination. When the first bogie 5 arrives at a storage place in the storing section 4, the first bogie 5 transfers the article W to the storage place. The following describes the transport of the article W with the use of the unloading unit 91, with reference to a process of transporting the article W stored in the storing section 4 to outside the automated warehouse 1.

As illustrated in FIGS. 1, 2, and 6, when the first bogie 5 arrives at a storage place of a target article W to be transported in the storing section 4, the first bogie 5 puts the article W thereon and travels on the first travel path R1. After that, the first bogie 5 is transferred from the first travel path R1 onto the second bogie 6 on the second travel path R2. The second bogie 6 carrying the article W and the first bogie 5 travels on the second travel path R2 and transfers the article W to the outbound section 93. The article W thus transported from the outbound section 93 to the second lifting and lowering device 95 is transferred to the unloading conveyor 96 and transported to outside the automated warehouse 1. Note that the outbound section 93 is a conveyor, similarly to the inbound section 92. FIG. 2 illustrates a case where the article W is a pallet Wa on which a load Wb is mounted, but the present invention is not limited to this.

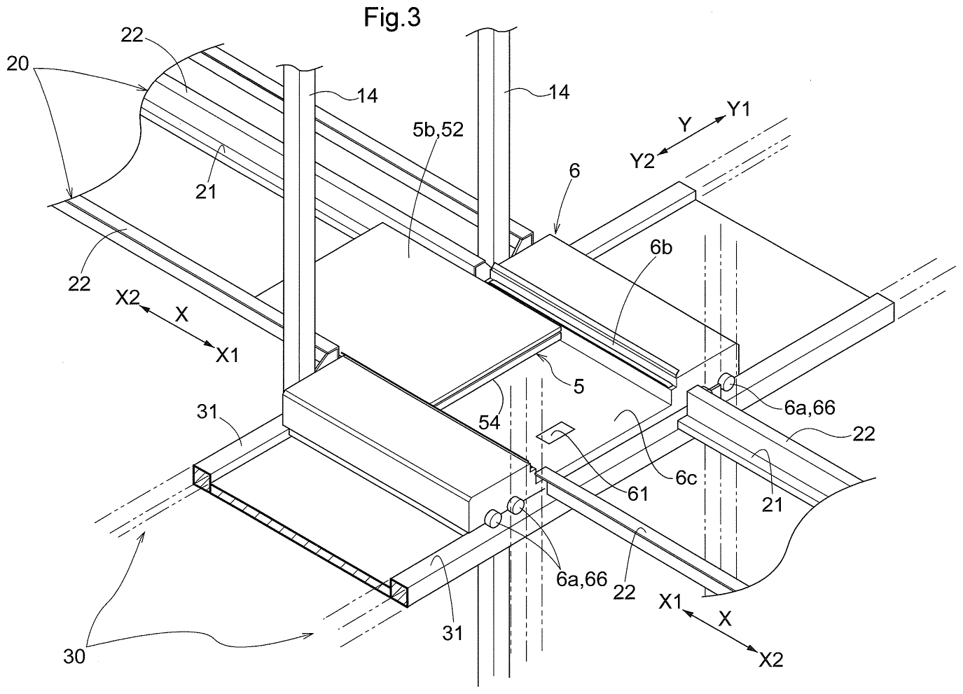

As illustrated in FIGS. 2, 3, the storage facility 3 includes a plurality of column supports 14 extending along the up-down direction. In the example of FIG. 2, the column support 14 is provided on a floor in a standing manner to extend upward in the up-down direction from the floor. The plurality of column supports 14 supports first rails 20 and second rails 30. The first rail 20 is a rail configured to guide the first bogie 5 in the first direction X. The first rail 20 is coupled to a plurality of column supports 14 arranged in the first direction X in such a manner as to be supported on the plurality of column supports 14. The second rail 30 is a rail configured to guide the second bogie 6 in the second direction Y. The second rail 30 is coupled to a plurality of column supports 14 arranged in the second direction Y in such a manner as to be supported on the plurality of column supports 14. Herein, the first travel path R1 is formed by a pair of first rails 20. Meanwhile, the second travel path R2 is formed by a pair of second rails 30.

The storing section 4 is formed by a pair of first rails 20. More specifically, as illustrated in FIG. 3, each of the pair of first rails 20 has a first travel surface 21 and a mounting surface 22 (herein, a surface facing upward) upward of the first travel surface 21. The mounting surface 22 continuously extends in the first direction X. When a plurality of articles W is arranged in the first direction X and put on the mounting surfaces 22, the plurality of articles W is stored in the storing section 4 in such a manner as to be arranged in the first direction X. Here, the article W is stored in the storing section 4 such that the opposite sides of the article W in the second direction Y are put on the mounting surface 22 of one of the pair of first rails 20 and the mounting surface 22 of the other one of the pair of first rails 20, respectively. When a direction toward the center between the pair of first rails 20 in the second direction Y is defined as “inward” in the second direction Y, and a direction opposite therefrom is defined as “outward” in the second direction Y, the mounting surface 22 is outward, in the second direction Y, of the first travel surface 21 of the same first rail 20 as the mounting surface 22, as illustrated in FIG. 3. Thus, a pair of first travel surfaces 21 defining the first travel path R1 in a single storing section 4 is between a pair of mounting surfaces 22 in the second direction Y which pair of mounting surfaces 22 defines the single storing section 4.

Here, the storage facility 3 is configured to store the article W under a particular temperature environment. In the present example, the storage facility 3 is configured to store the article W in a frozen state. More specifically, the inside of the storage facility 3 is under a low temperature environment under which fresh food, frozen food, or the like can be stored in a frozen state by a refrigerator (not illustrated) provided inside or outside the automated warehouse 1. In the present embodiment, the temperature of each of the plurality of storage floors 32 is adjusted to achieve the low temperature environment. Accordingly, the storing section 4 in each of the storage floors 32 is naturally under the low temperature environment. Thus, the first travel path R1 on which the first bogie 5 travels is also under the low temperature environment. In the present example, the second travel path R2 on which the second bogie 6 travels is also under the low temperature environment, similarly to the storing section 4, but the second travel path R2 may be under an ordinary temperature environment. Note that, in the present embodiment, the “particular temperature environment” indicates an environment different from an environment kept at ordinary temperature, e.g., a low temperature environment (herein, a temperature environment under which the article W can be stored in a frozen state), an environment having a large temperature difference between the storing section 4 and the other places (herein, the second travel path R2), or the like. The “low temperature environment” indicates an environment lower than the ordinary temperature and includes an environment adjusted to a temperature range for storing the article W in a refrigerated state, and an environment adjusted to a temperature range for storing the article W in a frozen state. Here, the temperature range for storing the article W in a refrigerated state is a temperature range higher than freezing temperature but lower than ordinary temperature and is, for example, a temperature range of around −5° C. to 10° C. The temperature range for storing the article W in a frozen state is a temperature range less than 0° C. and is, for example, a temperature range equal to or lower than around −15° C.

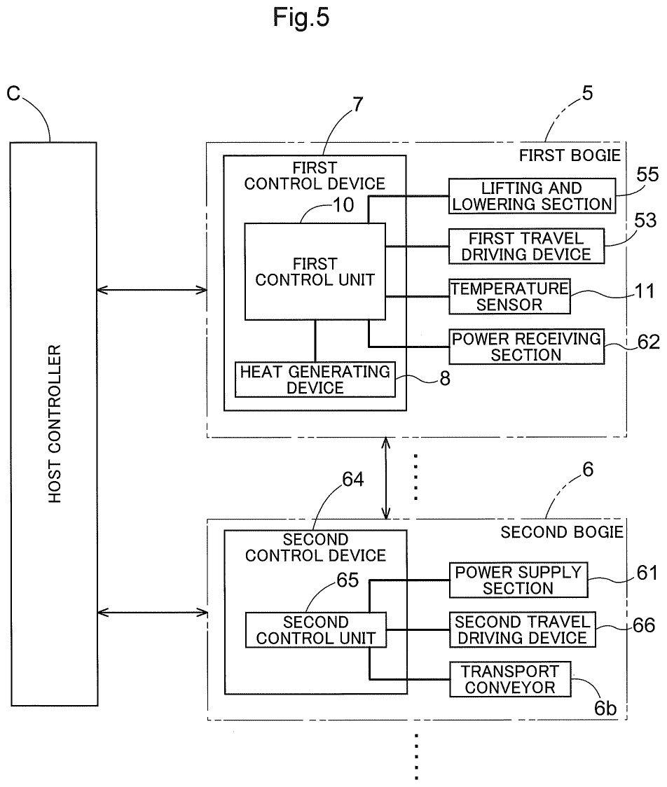

As illustrated in FIGS. 2 to 5, the second bogie 6 includes a transport conveyor 6b configured to support the article W and transport the article W in the second direction Y, a third rail 6c, a second travel driving device 66 (FIG. 5), and a power supply section 61. The second travel driving device 66 includes a second travel wheel 6a configured to roll on a second travel surface 31 as a travel surface (herein, a surface facing upward) of the second rail 30, an electric motor configured to drive the second travel wheel 6a, and a transmission mechanism configured to transmit a driving force of the electric motor to the second travel wheel 6a. While the second bogie 6 is at a position corresponding to a pair of first rails 20, the third rail 6c is connected to the pair of first rails 20. More specifically, the third rail 6c and the pair of first rails 20 is in a positional relationship where the third rail 6c and the pair of first rails 20 are aligned in a straight line. This allows the first bogie 5 to be transferred between the third rail 6c and the pair of first rails 20. The transport conveyor 6b transports the article W between the second bogie 6 and the inbound section 92 or the outbound section 93. In the example in FIG. 3, the third rail 6c has a groove shape to be recessed downward of the transport conveyor 6b supporting the article W. Note that the second bogie 6 may be a stacker crane, and the first bogie 5 may be configured to be separable from the stacker crane. In such a case, no second rail 30 is provided for each of the plurality of storage floors, but the second rails 30 are provided on the floor surface of the storage facility 3.

As illustrated in FIGS. 3, 5, the power supply section 61 supplies electric power to the first bogie 5. In the present embodiment, the power supply section 61 receives electric power from outside and supplies electric power to the first bogie 5. Herein, a feeder cable (not illustrated) is provided along the second travel path R2. The second bogie 6 receives electric power from the feeder cable and travels on the second travel path R2. Note that the feeder cable may supply electric power to the second bogie 6 in contact with the second bogie 6 or may contactlessly supply electric power to the second bogie 6. Instead of providing the feeder cable, a charging station for supplying electric power to the first bogie 5 can be provided. In the present embodiment, the power supply section 61 supplies electric power to the first bogie 5 while the second bogie 6 carries the first bogie 5. As illustrated in FIG. 3, the power supply section 61 is provided for the third rail 6c of the second bogie 6 and is disposed at a position where the power supply section 61 is in contact with a power receiving section 62 of the first bogie 5 while the second bogie 5 is supported on the second bogie 6 (more specifically, the third rail 6c). That is, the power supply section 61 supplies electric power in contact with the power receiving section 62. Note that the power supply section 61 may be configured to contactlessly supply electric power to the first bogie 5. The second bogie 6 also includes a second control device 64. The second control device 64 includes a second control unit 65. When the second control unit 65 acquires command information from a host controller C for controlling the whole automated warehouse 1, the second control unit 65 controls the second travel driving device 66 based on the command information. In addition, the second control unit 65 controls the power supply section 61 to supply electric power to the second bogie 6 in response to the first bogie 5 being put on the second bogie 6. The second control unit 65 controls the transport conveyor 6b to transfer the article W between the transport conveyor 6b and the inbound section 92 or the outbound section 93.

As illustrated in FIGS. 2 to 5, the first bogie 5 includes a power storage device 51, a first travel driving device 53, a support base 52 configured to support the article W from below, a travel main body 54, a lifting and lowering section 55 (FIG. 5) configured to lift and lower the support base 52 relative to the travel main body 54, the power receiving section 62 configured to receive electric power from the power supply section 61 of the second bogie 6, and a first control device 7. The first travel driving device 53 causes the first bogie 5 to travel with the use of electric power stored in the power storage device 51. The first travel driving device 53 includes a first travel wheel 5a configured to roll on the first travel surface 21 of the first rail 20 and the third rail 6c, a traction motor M1 (herein, an electric motor) configured to drive the first travel wheel 5a, and a transmission mechanism configured to transmit a driving force of the traction motor M1 to the first travel wheel 5a. The traction motor M1 rotates the first travel wheel 5a with the use of electric power stored in the power storage device 51. Herein, the first travel driving device 53 corresponds to a “travel driving device.”

As illustrated in FIG. 3, the support base 52 has a supporting surface 5b for supporting the article W. Herein, the supporting surface 5b is a surface of the support base 52 which surface faces upward. In a case where the first bogie 5 supports the article W and travels on the first travel path R1, the support base 52 is lifted so that the supporting surface 5b is at a position higher than the mounting surface 22. In a case where the first bogie 5 transfers the article W onto the mounting surface 22, the support base 52 is lowered so that the supporting surface 5b is at a position lower than the mounting surface 22. Hereby, the article W is put on the mounting surface 22. Similarly, in a case where the first bogie 5 supporting the article W is on the second bogie 6, the first bogie 5 lowers the support base 52 on the third rail 6c so that the supporting surface 5b is at a position lower than the transport surface of the transport conveyor 6b. Hereby, the article W is put on the transport conveyor 6b. The lifting and lowering of the support base 52 is performed by driving of the lifting and lowering section 55 (FIG. 5).

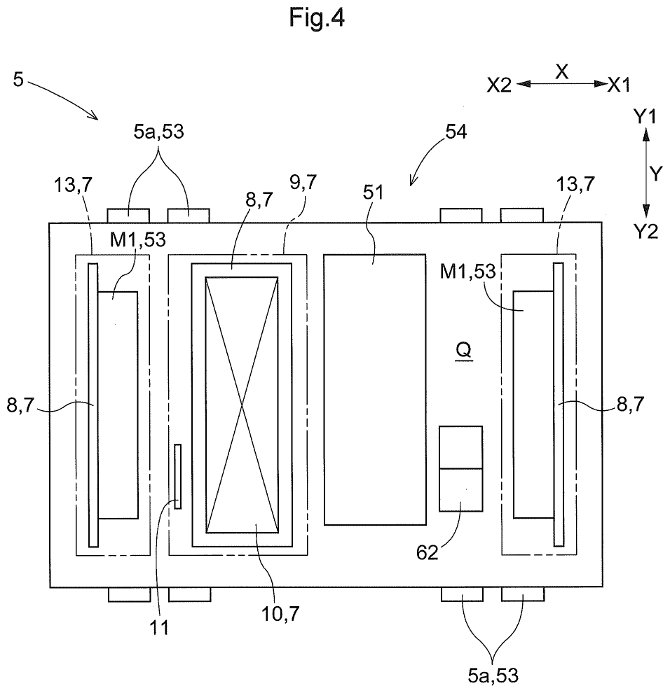

As illustrated in FIG. 4, the power storage device 51 stores electric power supplied from the power supply section 61 of the second bogie 6 to the power receiving section 62 of the first bogie 5. In the present embodiment, the power storage device 51 stores electric power supplied while the first bogie 5 is on the second bogie 6. Herein, the power storage device 51 is a capacitor but may be a battery.

The first control device 7 is configured to control the first travel driving device 53. In the present embodiment, as illustrated in FIGS. 4, 5, the first control device 7 includes a first control unit 10 configured to generate a control signal for the first travel driving device 53, a heat generating device 8 configured to generate heat with the use of at least either electric power supplied from the power supply section 61 or electric power stored in the power storage device 51, and a first thermally insulated case 9 made of a heat insulation material. Here, the first control device 7 corresponds to a “control device,” the first control unit 10 corresponds to a “control unit,” and the first thermally insulated case 9 corresponds to a “thermally insulated case.” In the present embodiment, the heat generating device 8 is a heater configured to generate heat by current application. In the present embodiment, the heat generating device 8 generates heat with the use of electric power stored in the power storage device 51. As illustrated in FIG. 4, the travel main body 54 is provided with a plurality of heat generating devices 8. The first control device 7 includes a second thermally insulated case 13 in addition to the first thermally insulated case 9. The second thermally insulated case 13 is also made of a heat insulation material, similarly to the first thermally insulated case 9. In the present example, as illustrated in FIG. 4, the first control device 7 (the first control unit 10, the heat generating device 8, and the first thermally insulated case 9) is stored in an internal space Q of the travel main body 54. The power storage device 51, a first traction motor M1 and a transmission mechanism (not illustrated) of the travel driving device 53, the power receiving section 62, the first thermally insulated case 9, and the second thermally insulated case 13 are also stored in the internal space Q. A plurality of first travel wheels 5a as the first travel driving device 53 and the lifting and lowering section 55 (not illustrated) are attached to the travel main body 54.

As illustrated in FIG. 5, when the first control unit 10 acquires command information from the host controller C for controlling the whole automated warehouse 1, the first control unit 10 controls the first travel driving device 53 based on the command information. The first control unit 10 controls the lifting and lowering section 55 to adjust the height of the supporting surface 5b at the time when the first bogie 5 moves on the first travel path R1 and the second travel path R2. The first control unit 10 controls the power receiving section 62 to receive electric power supplied from the power supply section 61 of the second bogie 6. In the present embodiment, the first control unit 10, the second control unit 65, and the host controller C are configured to be communicable with each other. These control units and the host controller C each include a processor such as a microcomputer, and a peripheral circuit such as a memory, and a function of each of the control units and the host controller C control device H is implemented in collaboration of these pieces of hardware and a program executed on hardware such as the processor. Note that FIG. 5 illustrates a configuration in which each of the first control unit 10 and the second control unit 65 directly communicates with the host controller C, but either one of the first control unit 10 and the second control unit 65 may communicate with the host controller C via the other one of the first control unit 10 and the second control unit 65.

As described above, the first bogie 5 travels under a low temperature environment under which the article W can be stored in a frozen state. In a case where a device or a component vulnerable to low temperature is used for the first bogie 5, the first bogie 5 easily causes a malfunction, which may decrease the operating rate of a facility. In view of this, by protecting the device or component vulnerable to low temperature, it is possible to restrain the first bogie 5 traveling under a low temperature environment from causing a malfunction. In the present embodiment, the first control unit 10 is protected from low temperature by warming the first control unit 10 by heat generated by the heat generating device 8. Herein, the first control unit 10 includes a control substrate constituting a control circuit. In the present embodiment, since the first control unit 10 is protected from low temperature with the use of heat generated by the heat generating device 8, it is not necessary that the first control unit 10 use a control substrate, a component, or the like usable at low temperature, for example, thereby making it possible to achieve a cost reduction.

As illustrated in FIG. 4, the first control unit 10 and the heat generating device 8 are stored in the first thermally insulated case 9. The first traction motor M1 included in the travel driving device 53 and the heat generating device 8 are stored in the second thermally insulated case 13. In addition, in the present embodiment, as illustrated in FIG. 4, the automated warehouse 1 further includes a temperature sensor 11 configured to detect a temperature in the first thermally insulated case 9. In the present example, the temperature sensor 11 is provided inside the first thermally insulated case 9. That is, the temperature sensor 11 is also stored inside the first thermally insulated case 9, in addition to the first control unit 10 and the heat generating device 8. In the meantime, no temperature sensor 11 is provided inside the second thermally insulated case 13.

In FIG. 4, a plurality of second thermally insulated cases 13 and the first thermally insulated case 9 are disposed in the internal space Q of the travel main body 54. A pair of second thermally insulated cases 13 is provided to be separated from each other in the first direction X. Each of the second thermally insulated cases 13 stores the traction motor M1 and the heat generating device 8. The traction motor M1 is protected from low temperature by heat generated by the heat generating device 8. It is known that some magnets used in an electric motor or the like are demagnetized when the temperature decreases to low temperature from ordinary temperature, and even when the temperature is increased to the ordinary temperature from the low temperature, the magnetic force of the magnets is not restored. One of the purposes of protecting the traction motor M1 from low temperature by warming the traction motor M1 is to restrain demagnetization at low temperature in a magnet used for a motor with the use of heat generated by the heat generating device 8. In a case where a control substrate attached to the traction motor M1, a component vulnerable to low temperature, or the like is used, the control substrate, the component vulnerable to low temperature, or the like is also protected from low temperature with the use of heat generated by the heat generating device 8.

In the example of FIG. 4, the second thermally insulated case 13, the power storage device 51, the first thermally insulated case 9, and the second thermally insulated case 13 are disposed in the internal space Q of the travel main body 54 in this order from the first-direction first side X1, but the arrangement of them can be modified appropriately. The first control unit 10, the traction motor M1, and the heat generating device 8 can be also stored in the first thermally insulated case 9 without additionally providing the second thermally insulated case 13 different from the first thermally insulated case 9 in the internal space Q. Depending on the type of the traction motor M1, the traction motor M1 may not necessarily be stored in a thermally insulated case (the first thermally insulated case 9 or the second thermally insulated case 13). The power storage device 51 may be stored in a thermally insulated case. Particularly, it is preferable that the power storage device 51 be stored in the thermally insulated case in a case where the power storage device 51 is a battery. On the other hand, a heat insulation material may be attached to the travel main body 54 to cover the internal space Q. In that case, the travel main body 54 itself functions as a thermally insulated case. Note that the second control device 64 of the second bogie 6 may also include the heat generating device 8 and a thermally insulated case, and the heat generating device 8 and the second control unit 65 may be stored in the thermally insulated case.

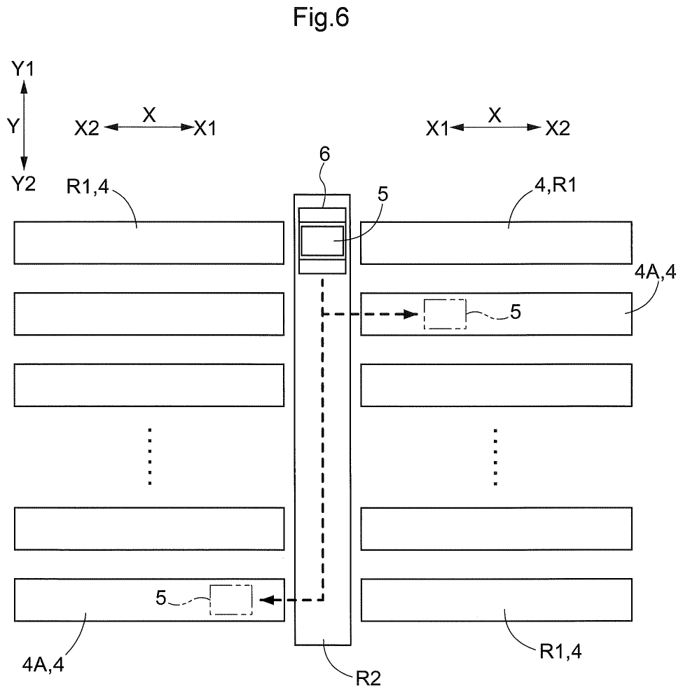

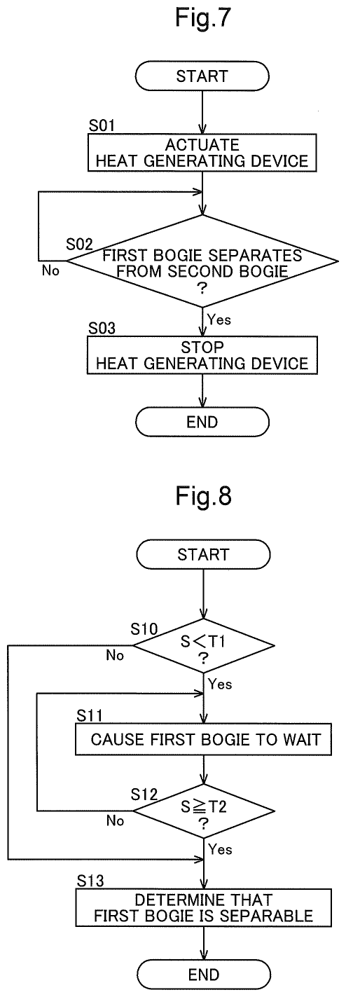

In the present embodiment, as illustrated in FIGS. 6, 7, the first control unit 10 performs a stop control. More specifically, the first control unit 10 actuates the heat generating device 8 with the first bogie 5 being on the second bogie 6 and stops the heat generating device 8 with the first bogie 5 being away from the second bogie 6 and being in the storing section 4. In the present example, the host controller C designates a target storing section 4A to the first control device 7 and the second control device 64 and transmits command information to cause the first bogie 5 to travel to the target storing section 4A. Herein, the target storing section 4A is a storing section 4 as a travel destination of the first bogie 5. This command information is transmitted in a case where the article W is transported to the target storing section 4A and in a case where the article W is transported from the target storing section 4A. While the first bogie 5 is on the second bogie 6, that is, while the first bogie 5 is on the second travel path R2, the first control unit 10 actuates the heat generating device 8 (S01) in either of the case where the article W is transported to the target storing section 4A and the case where the article W is transported from the target storing section 4A. In the present example, the plurality of heat generating devices 8 is all actuated while the first bogie 5 is on the second bogie 6.

When the first bogie 5 separates from the second bogie 6 (S02: Yes), the first control unit 10 stops the operation of the heat generating device 8 (S03). More specifically, when the first bogie 5 separates from the second bogie 6 and is transferred onto the first travel path R1 in the storing section 4, the first control unit 10 stops the operations of all the plurality of heat generating devices 8. While the first bogie 5 is in the storing section 4, power supply from the power storage device 51 to the heat generating device 8 also stops, and therefore, power consumption of the power storage device 51 due to the operation of the heat generating device 8 can be restrained. Thus, in comparison with a case where the heat generating device 8 is actuated regardless of the state of the first bogie 5, it is possible to downsize the power storage device 51. In the meantime, since the plurality of (herein, three) heat generating devices 8 is each stored in a corresponding thermally insulated case (the first thermally insulated case 9 or the second thermally insulated case 13), even when the heat generating devices 8 are inactive, a thermally insulated state in the thermally insulated case is easily maintained. Accordingly, even when the first bogie 5 repeatedly travels in the storing section 4 under a low temperature environment, the first control unit 10, the traction motor M1, or the like is less likely to cause a malfunction. Note that, in the present example, even when the heat generating device 8 stops because the first bogie 5 is away from the second bogie 6 and is in the storing section 4, the first control unit 10 may actuate the heat generating device 8 again under a given condition. For example, in a case where the temperature inside at least one of the first thermally insulated case 9 and the second thermally insulated case 13 becomes equal to or lower than a predetermined temperature, even when the first bogie 5 is in the storing section 4, the first control unit 10 may change all or some of the plurality of heat generating devices 8 from a stopped state to an operating state.

In the present example, as described above, the temperature sensor 11 is provided inside the first thermally insulated case 9. As illustrated in FIG. 6, for example, in a case where a target storing section 4A to which the article W is transported first is distanced in the second direction Y from a target storing section 4A to which the article W is transported next, the second bogie 6 travels a relatively long distance with the first bogie 5 being on the second bogie 6. In a case where the second bogie 6 repeatedly travels a relatively long distance, a period during which the first bogie 5 is on the second bogie 6 becomes long, and a period during which the heat generating device 8 operates also becomes long, so that the temperature in the first thermally insulated case 9 is easily maintained within an appropriate temperature range. In the meantime, in a case where the target storing section 4A to which the article W is transported first is close, in the second direction Y, to the target storing section 4A to which the article W is transported next, the second bogie 6 travels a relatively short distance with the first bogie 5 being on the second bogie 6. In a case where the target storing section 4A to which the article W is transported first is adjacent to the target storing section 4A to which the article W is transported next across the second travel path R2, the first bogie 5 moves between the target storing sections 4A adjacent to each other via the second bogie 6 while the second bogie 6 is stopping. In a case where such a transport control is repeated, a period during which the first bogie 5 is on the second bogie 6 becomes short, and a period during which the heat generating device 8 operates also becomes short. In brief, since a period during which the first bogie 5 travels in the storing section 4 (herein, the first travel path R1) becomes longer than the period during which the first bogie 5 is on the second bogie 6, a period during which the heat generating device 8 operates becomes insufficient, so that it is difficult to maintain the temperature in the first thermally insulated case 9 within an appropriate temperature range. In view of this, the first control unit 10 performs a thermal management control to easily maintain the inside of the first thermally insulated case 9 within an appropriate temperature range even under any transport command. The following describes the thermal management control more specifically.

As illustrated in FIG. 8, in a case where the first bogie 5 is on the second bogie 6 and a temperature S detected by the temperature sensor 11 is lower than a first threshold T1, the first control unit 10 causes the first bogie 5 to wait with the first bogie 5 being on the second bogie 6 until the temperature S detected by the temperature sensor 11 reaches a second threshold T2 set to be equal to or larger than the first threshold T1. In the present example, in a case where the first bogie 5 is transferred from the storing section 4 to the second bogie 6 and the temperature S detected by the temperature sensor 11 is lower than the first threshold TI (S10: Yes), the first control unit 10 causes the first bogie 5 to wait with the first bogie 5 being on the second bogie 6 regardless of whether a subsequent transport command is transmitted or not (S11). Hereby, the operation of the heat generating device 8 is continued, so that the temperature in the first thermally insulated case 9 increases. In a case where the temperature S detected by the temperature sensor 11 is equal to or higher than the second threshold T2 (S12: Yes), the first control unit 10 determines that the first bogie 5 is separable from the second bogie 6 (S13). In a case where it is necessary to move the first bogie 5 to the target storing section 4A in response to a transport command received from the host controller C, the first control unit 10 causes the first bogie 5 to be transferred to the target storing section 4A from a position on the second travel path R2 which position corresponds to the target storing section 4A. In the present embodiment, the second threshold T2 is the same value as the first threshold. Note that the temperature sensor 11 may be also provided inside the second thermally insulated case 13. In a case where at least some of temperatures S detected by the temperature sensors 11 are lower than the first threshold TI with the first bogie 5 being on the second bogie 6, the first control unit 10 may cause the first bogie 5 to wait with the first bogie 5 being on the second bogie 6 until all the temperatures S detected by the temperature sensors 11 reach the second threshold T2 set to be equal to or higher than the first threshold. In this case, the first threshold TI and the second threshold T2 may not be values common to all the temperature sensors 11 but may vary depending on the temperature sensors 11.

Note that, in a case where the first bogie 5 is on the second bogie 6 and is waiting on a specified storage floor 32, when the first control unit 10 receives a new transport command from the host controller C, the first bogie 5 or the second bogie 6 may transmit, to the host controller C, information indicating that the first bogie 5 is waiting. In such a case, the host controller C can set a target storing section 4A in a new transport command to a different storage floor 32. Hereby, while the first bogie 5 in the specific storage floor 32 is kept waiting, an article transport control in response to the new transport command can be performed in the different storage floor 32.

Therefore, even while the first bogie 5 is waiting in the specific storage floor 32 due to the thermal management control, it is possible to restrain a decrease in transport efficiency of the article W in a whole facility.

### Other Embodiments

(1) The above embodiment has described, as an example, the configuration in which the heat generating device 8 generates heat with the use of electric power stored in the power storage device 51. However, the present invention is not limited to this. For example, the heat generating device 8 may generate heat with the use of electric power supplied from the power supply section 61. More specifically, the heat generating device 8 may be configured to generate heat directly with the use of electric power supplied from the power supply section 61 of the second bogie 6 without the power storage device 51.

(2) The above embodiment has described, as an example, the configuration in which the first control unit 10 actuates the heat generating device 8 with the first bogie 5 being on the second bogie 6 and stops the heat generating device 8 with the first bogie 5 being away from the second bogie 6 and being in the storing section 4. However, the present invention is not limited to this. The first control unit 10 may cause the heat generating device 8 to continue operating regardless of whether or not the first bogie 5 is on the second bogie 6. For example, the first control unit 10 may cause all or some of the heat generating devices 8 to continue operating even when the first bogie 5 separates from the second bogie 6 and travels in the storing section 4 (herein, the first travel path R1). Alternatively, the first control unit 10 may selectively perform a stop control in which the first control unit 10 actuates the heat generating device 8 with the first bogie 5 being on the second bogie 6 and stops the heat generating device 8 while the first bogie 5 is in the storing section 4 and a continuation control in which the first control unit 10 causes the heat generating device 8 to continue operating even while the first bogie 5 is in the storing section 4. In this case, either the stop control or the continuation control may be performed depending on the period during which the first bogie 5 is on the second bogie 6 or the period (a period during which the first bogie 5 is on the second bogie 6) during which the first bogie 5 is on the second travel path R2, for example.

(3) The above embodiment has described, as an example, the configuration in which, in a case where the first bogie 5 is on the second bogie 6 and the temperature S detected by the temperature sensor 11 is lower than the first threshold T1, the first control unit 10 causes the first bogie 5 to wait with the first bogie 5 being on the second bogie 6 until the temperature S detected by the temperature sensor 11 reaches the second threshold T2 set to the same value as the first threshold T1. However, the present invention is not limited to such a configuration, and in a case where the first bogie 5 is on the second bogie 6 and the temperature S detected by the temperature sensor 11 is lower than the first threshold T1, the first control unit 10 can cause the first bogie 5 to wait with the first bogie 5 being on the second bogie 6 until the temperature S detected by the temperature sensor 11 reaches the second threshold T2 larger than the first threshold T1.

(4) The above embodiment has described, as an example, the configuration in which the storage facility 3 includes a plurality of storage floors 32 arranged in the up-down direction, each of the storage floors 32 is provided with a plurality of storing sections 4, and each of the storage floors 32 is provided with the second bogie 6. However, the present invention is not limited to this. The storage facility 3 may include only a single storage floor 32, and the storage floor 32 may be provided with a plurality of storing sections 4, for example. Alternatively, each of the storage floors 32 may not be provided with the second bogie 6, for example, and one second bogie 6 can be provided for a given number of storage floors 32.

(5) The above embodiment has described, as an example, the configuration in which the traction motor M1 is stored in a thermally insulated case (the second thermally insulated case 13 in the example of the embodiment). However, the present invention is not limited to such a configuration, and a motor (for example, an electric motor configured to drive the lifting and lowering section 55) other than the traction motor M1 provided for the first bogie 5 may be stored in a thermally insulated case, instead of the traction motor M1. Alternatively, the traction motor M1 and the motor other than the traction motor M1 may be stored in a common thermally insulated case or in different thermally insulated cases.

(6) Note that the configurations disclosed in the above embodiment can be applied in combination with the configurations disclosed in other embodiments (including combinations of the embodiments described as the other embodiments) as long as no inconsistency occurs. In terms of other configurations, the embodiments disclosed in the present specification are also just examples in all respects. Accordingly, various modifications can be made appropriately as far as it does not deviate from the scope of this disclosure.

### Overview of Embodiments

The embodiments of the automated warehouse described above will be summarized below.

An automated warehouse according to this disclosure includes: a storage facility including a plurality of storing sections in each of which articles are storable to be aligned in a first direction as a particular direction along a horizontal plane, the plurality of storing sections being arranged in a second direction intersecting with the first direction as viewed vertically; a first bogie configured to travel along the first direction and transport an article in a corresponding storing section; and at least one second bogie capable of carrying the first bogie and configured to travel along the second direction outside the plurality of storing sections. The at least one second bogie includes a power supply section configured to supply electric power to the first bogie. The first bogie includes: a power storage device; a travel driving device configured to cause the first bogie to travel with use of electric power stored in the power storage device; and a control device configured to control the travel driving device. The control device includes: a control unit configured to generate a control signal for the travel driving device; a heat generating device configured to generate heat with use of at least either the electric power supplied from the power supply section or the electric power stored in the power storage device; and a thermally insulated case made of a heat insulation material. The control unit and the heat generating device are stored in the thermally insulated case.

With this configuration, even in a case where the control unit of the first bogie includes a component vulnerable to low temperature or temperature changes, the control unit is warmed by heat generated by the heat generating device, so that the control unit is easily maintained within an allowable temperature range. Accordingly, even in a case where the first bogie travels under a particular temperature environment such as a low temperature environment or an environment with a large temperature difference, for example, it is possible to reduce the rate of occurrence of a malfunction in the control unit.

In addition, in this configuration, since the control unit and the heat generating device are stored in the thermally insulated case, heat generated by the heat generating device is easily kept inside the thermally insulated case, and electric power to be consumed by the heat generating device is easily restrained. Accordingly, it is possible to downsize the power storage device of the first bogie.

Thus, with this configuration, in the automated warehouse including the first bogie configured to transport an article and the second bogie capable of carrying the first bogie, even when the first bogie travels under a particular temperature environment, it is possible to reduce the rate of occurrence of a malfunction in the first bogie and to restrain a decrease in the rate of operation of a facility.

Here, the control unit may actuate the heat generating device with the first bogie being on the at least one second bogie and stop the heat generating device while the first bogie is away from the at least one second bogie and is in any of the storing sections.

In this configuration, the heat generating device does not consume electric power while the first bogie is away from the power supply section of the second bogie and is in the storing section. Accordingly, during this period, it is not necessary for the power storage device to supply electric power to the heat generating device, thereby making it possible to easily downsize the power storage device and eventually to easily achieve downsizing of the first bogie and a cost reduction.

In the configuration where the heat generating device is stopped while the first bogie is away from the at least one second bogie and is in any of the storing sections, the automated warehouse may further include a temperature sensor configured to detect a temperature in the thermally insulated case, and in a case where the first bogie is on the second bogie and the temperature detected by the temperature sensor is lower than a first threshold, the control unit may cause the first bogie to wait with the first bogie being on the at least one second bogie until the temperature detected by the temperature sensor reaches a second threshold set to be equal to or higher than the first threshold.

In this configuration, in a case where the temperature detected by the temperature sensor is lower than the first threshold, the control unit causes the first bogie to wait with the first bogie being on the second bogie without causing the first bogie to travel. Accordingly, even in the configuration in which the heat generating device is stopped while the first bogie is away from the second bogie and is in the storing section, it is possible to easily keep the control unit in an allowable temperature range and to reduce the rate of occurrence of a malfunction in the control unit while the first bogie is traveling.

In addition, the storage facility may include a plurality of storage floors arranged in an up-down direction, the plurality of storing sections may include a plurality of storing sections provided for each of the plurality of storage floors, and the at least one second bogie may include second bogies each of which is provided for each of the plurality of storage floors and is configured to travel on a path along the second direction which path is provided in the each of the plurality of storage floors.

In this configuration, since the storage facility includes a plurality of storage floors arranged in the up-down direction, it is possible to secure many storing sections that can store articles in a frozen state. Besides, since the article can be transported with the use of the first bogie and the second bogie in each of the plurality of storage floors, it is possible to easily increase the article transport efficiency.

The automated warehouse according to this disclosure should be able to achieve at least one of the above effects.

What is claimed is:

1. An automated warehouse, comprising:
a storage facility comprising a plurality of storing sections in each of which articles are storable to be aligned in a first direction as a particular direction along a horizontal plane, the plurality of storing sections arranged in a second direction intersecting with the first direction as viewed vertically;
a first bogie configured to travel along the first direction and transport an article in a corresponding storing section; and
at least one second bogie capable of carrying the first bogie and configured to travel along the second direction outside the plurality of storing sections,
wherein:
the at least one second bogie comprises a power supply section configured to supply electric power to the first bogie, and
the first bogie comprises:
a power storage device;
a travel driving device configured to cause the first bogie to travel with use of electric power stored in the power storage device; and
a control device configured to control the travel driving device, the control device comprises:
a control unit configured to generate a control signal for the travel driving device;
a heat generating device configured to generate heat with use of at least either the electric power supplied from the power supply section or the electric power stored in the power storage device; and
a thermally insulated case made of a heat insulation material, and the control unit and the heat generating device are stored in the thermally insulated case.

2. The automated warehouse according to claim 1, wherein:
the control unit actuates the heat generating device with the first bogie being on the at least one second bogie and stops the heat generating device while the first bogie is away from the at least one second bogie and is in any of the storing sections.

3. The automated warehouse according to claim 2, further comprising:
a temperature sensor configured to detect a temperature in the thermally insulated case, and
wherein in a case where the temperature detected by the temperature sensor is lower than a first threshold, the control unit causes the first bogie to wait with the first bogie being on the at least one second bogie until the temperature detected by the temperature sensor reaches a second threshold set to be equal to or higher than the first threshold.

4. The automated warehouse according to claim 1, wherein:
the storage facility comprises a plurality of storage floors arranged in an up-down direction,
the plurality of storing sections comprises a plurality of storing sections provided for each of the plurality of storage floors, and
the at least one second bogie comprises second bogies each of which is provided for each of the plurality of storage floors and is configured to travel on a path along the second direction which path is provided in the each of the plurality of storage floors.
